(19) United States
(12) Patent Application Publication
(10) Pub. No.: US 2019/0126596 A1
(43) Pub. Date: May 2, 2019

(54) POLYMER FOAM INSULATION STRUCTURES HAVING A FACING LAYER OF A POLYLACTIDE RESIN

(71) Applicant: NatureWorks LLC, Minnetonka, MN (US)

(72) Inventors: Nemat Hossieny, Medina, MN (US); Osei A. Owusu, Plymouth, MN (US); Manuel A. W. Natal, Eden Prairie, MN (US); Richard Douglas Benson, Long Lake, MN (US)

(21) Appl. No.: 16/094,264

(22) PCT Filed: Apr. 24, 2017
(86) PCT No.: PCT/US2017/029192

§ 371 Date: Oct. 17, 2018

Related U.S. Application Data
(60) Provisional application No. 62/329,124, filed on Apr. 28, 2016.

(51) Int. Cl. B32B 27/06; F25D 23/06; E04B 1/74; B32B 5/20; B32B 27/28; B29C 44/06

(52) U.S. Cl. CPC B32B 27/065; F25D 23/065; E04B 1/74; B32B 5/20; B60P 3/20; B29C 44/06; F25D 2201/126; E04B 2001/742; B32B 27/28

(57) ABSTRACT

Thermal insulation structures include a polymer foam layer adhered to a non-cellular sheet of a polylactide resin. The polylactide resin is a surprisingly good barrier to the diffusion of atmospheric gases into and blowing agents out of the foam layer. Accordingly, the diffusion of atmospheric gases and the blowing agents is retarded substantially. This greatly reduces the loss of thermal insulation capacity of the structure due to the replacement of the blowing agent with atmospheric gases.

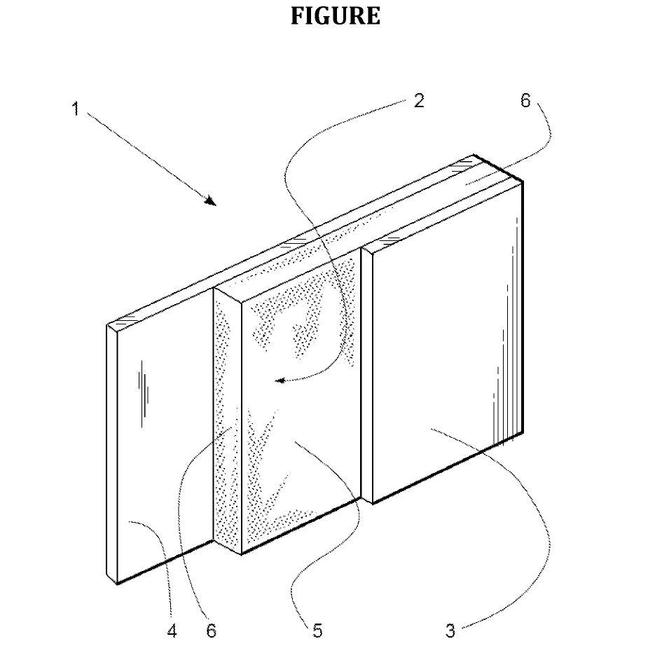

This invention relates to polymer foam insulation structures that have a facing sheet on one or more sides of a layer of a polymer foam.

Foam insulation structures are produced in large quantities worldwide. Cabinets and doors for appliances such as refrigerators and freezers represent a significant segment of the market for these structures, but these structures are also useful as thermal insulation for buildings and other constructions, for insulating refrigerated trucks and ship hulls, and for many other uses.

The thermal insulation structures include a polymer foam layer, which is the primary insulating element. The structures also include a facing layer on one or both sides of the polymer foam layer. A facing layer may provide attributes such as strength and stiffness. A facing layer may serve as a protective layer to prevent damage to the foam and may include specific aesthetic or functional features as may be wanted in particular applications.

The polymer foam layer is a cellular material consisting of both closed and open cell morphologies. The cells of the foam are filled with gas. Initially, the gas consists of the blowing agents that are used to produce the foam. Over time, atmospheric gases diffuse into the foam and the blowing agents diffuse out of the foam and become replaced with atmospheric gases. Because the blowing agents are usually a better thermal insulator than the atmospheric gases, the loss of blowing agents leads to a decline in the thermal insulation properties of the structure over time. Certain facing layers retard the rate of blowing agent loss by forming a diffusion barrier.

In refrigerator and freezer cabinets and doors, the polymer foam layer typically is sandwiched between an exterior face (usually a metal such as steel) and an inner polymeric liner. The exterior face provides mechanical strength and puncture resistance. Polymeric materials are chosen for the inner liner material for several reasons, including their lower weight, their ability to be inexpensively thermoformed into complex shapes, and for other aesthetic or functional reasons.

Acrylonitrile-butadiene-styrene (ABS) and high-impact polystyrene (HIPS) resins are most frequently used to make the inner liner. Unfortunately, both of these materials are rather poor diffusion barriers for many gases, including the blowing agents most often used to make the polymer foam. Therefore, atmospheric gases diffuse into the foam and blowing agents diffuse out of the foam and through the liner. Over time, the cabinet becomes less efficient as a thermal insulator and the appliance itself becomes less energy efficient. It would be desirable to provide a foam insulation structure having a better performing inner liner material.

In one aspect, this invention is a foam insulation structure comprising (a) a polymer foam layer having opposing major surfaces and gas-filled cells that contain a physical blowing agent and (b) a non-cellular polylactide sheet containing at least 50% by weight of one or more polylactide resins, wherein said non-cellular polylactide sheet (b) is sealingly affixed to at least one of said opposing major surfaces of the polymer foam layer.

It has been found, very surprisingly, the polylactide resin sheet forms a highly effective barrier to the permeation of atmospheric gases and certain blowing agents from the insulation foam. The foam insulation structure of the invention therefore experiences a surprisingly slow loss of thermal insulation efficiency over time due to the slow diffusion of atmospheric gases and of blowing agents through the polylactide sheet.

In many cases, as with many refrigerators and freezers, the insulation foam layer is produced in a so-called “pour-in-place” process, in which liquid foam precursors are applied to and react at the surface of the facing layer(s) to form the foam. The foam so produced adheres to the facing layer(s) to form the foam insulation structure. The foam precursors in such processes typically include at least one polyisocyanate, water, a physical blowing agent, and most typically one or more polyols. The foaming reaction is exothermic and can produce local temperatures of 60° C. to 160° C. or more. There is a thermal gradient between the core of the foam and the surface of the liner; with the liner expected to withstand temperatures between 60 and 90° C. Any candidate for use as a liner material must be able to withstand these temperatures and contact with the reactive precursors.

Surprisingly, it has been found that a semi-crystalline polylactide is capable of withstanding exposure to the precursors and the temperatures produced by the exothermic foaming reaction in a pour-in-place process. Accordingly, the invention in another aspect is a method for producing a foam insulation structure comprising (1) applying a foam precursor mixture containing at least one polyisocyanate, water, polyol and a physical blowing agent to the surface of a non-cellular polylactide sheet that contains at least 50% by weight of a polylactide resin, which sheet contains at least 25 Joules of polylactide crystallites per gram of polylactide resin in the non-cellular polylactide sheet, and (2) curing the foam precursor mixture while in contact with the non-cellular polylactide sheet to form a polymer foam layer adhered to the polylactide sheet.

In specific embodiments, the foam insulation structure includes the polymer foam layer, a layer of a non-cellular polylactide resin sealingly affixed to one major surface of the polymer foam layer, and a second facing layer sealingly affixed to the opposing major surface of the polymer foam layer. Embodiments of this type may take the form of an appliance housing, such as a refrigerator or freezer cabinet or door.

The FIGURE is a perspective view, partially in section, of an embodiment of a foam insulation structure of the invention.

In the FIGURE, foam insulation structure 1 includes polymer foam layer 2 having a major surface 5 and an opposing major surface (obscured in this view). Non-cellular polylactide sheet 3 is sealingly affixed to polymer foam layer 2.

By “non-cellular” it is meant the polylactide sheet has a void volume of no greater than 10 volume-%. It more preferably has a void volume of no greater than 5 volume-%, and still more preferably no greater than 2 volume-%.

By “sealingly affixed” it is meant that there are no openings (apart from manufacturing defects, if any) between polymer foam layer 2 and polylactide sheet 3 through which bulk transport of gas in or out of foam insulation structure 1 takes place. Therefore, gas moving into and out of polymer foam layer 2 through major surface 5 therefore must diffuse through polylactide sheet 3 to enter or escape from that side of the structure 1. Typically, polylactide sheet 3 is sealingly affixed to polymer foam layer 2 by virtue of being adhered thereto, either directly or, less preferably, through an intermediate adhesive layer (not shown in the FIGURE). Polylactide sheet 3 preferably is in direct contact with a major surface of polymer foam layer 2 or in direct contact with an adhesive layer that itself is in direct contact with polymer foam layer 2.

The “major” surfaces of any layer are the opposing surfaces that have the greatest surface areas. The “thickness” of any layer or of the structure as a whole is the smallest orthogonal dimension.

Polymer foam layer 2 is a cellular organic polymer (or mixture of organic polymers). The cells of the polymer foam are filled with one or more gases. The gases include one or more volatilized blowing agents. The cells preferably are mainly closed cells. For example, at least 50%, at least 75%, or at least 90% of the cells of the polymer foam may be closed cells, as determined according to ASTM D6226.

The physical blowing agent is one or more compounds having a boiling temperature of −10° C. to 100° C. The physical blowing agent volatilizes during the production of the polymer foam to produce a gas that expands the polymer. The physical blowing agent may include, for example, a hydrocarbon such as a linear or branched alkane having 3 to 8 carbon atoms and/or a cycloalkane having 4 to 8 carbon atoms. The physical blowing agent may be a fluorocarbon, hydrofluorocarbon, fluorochlorocarbon, or hydrofluorochlorocarbon up to 8 carbon atoms such as, for example, 1,1,1,3,3-pentafluoropropane (HFC-245fa), 1,1,1,3,3-pentafluorobutane (HFC-365mfc), 1,1,1,2,3,3,3-heptafluoropropane (HFC-227ea), 1,1,1,2-tetrafluoroethane (HFC-134a); a hydrohaloolefin blowing agent such as trifluoropropene, 1,3,3,3-tetrafluoropropene (1234ze); 1,1,3,3-tetrafluoropropene; 2,2,3,3-tetrafluoropropene (1234yf), 1,2,3,3,3-pentafluoropropene (1225ye); 1,1,1-trifluoropropene; 1,1,1,3,3-pentafluoropropene (1225zc); 1,1,2,3,3-pentafluoropropene (1225yc); (Z)-1,1,1,2,3-pentafluoropropene (1225yez); 1-chloro-3,3,3-trifluoropropene (1233zd) and 1,1,1,4,4,4-hexafluorobut-2-ene (1336mzzm), a dialkyl ether such as dimethyl ether, ethyl methyl ether or diethyl ether, and the like.

Preferred physical blowing agents include hydrocarbons, especially one or more alkanes having 3 to 6 carbon atoms such as n-butane, iso-butane, n-pentane, iso-pentane, n-hexane, iso-hexane, and one or more cycloalkanes such as cyclobutane, cyclopentane, cyclohexane, cycloheptane and cyclooctane. Cyclopentane is an especially preferred physical blowing agent. The physical blowing agent may constitute, for example, 10 to 100, 25 to 100, 25 to 95, or 25 to 75 mole percent of the gas in the cells of the polymer foam.

The gas within the cells of polymer foam layer 2 may consist entirely of the physical blowing agent(s) or may in addition contain one or more other gases. In some embodiments, the gas includes one or more compounds produced by the reaction of a chemical blowing agent such as carbon dioxide (as produced, for example, by reaction of water with an isocyanate group and/or the decomposition of formic acid or formic acid ester) or nitrogen (as produced, for example, by the decomposition of an azo blowing agent). The gas in the cells may in addition include other gaseous compounds such as air or one or more components of air. Such other gas or gases, if present, may constitute, for example, 5 to 75 or 25 to 75 mole percent of the gas in the cells of the polymer foam.

The polymer foam may include one or more thermoplastic polymers and/or one or more thermoset polymers. Thermoplastic polymers include, for example, polystyrene; styrene copolymers such as styrene-acrylonitrile copolymers and styrene-acrylic acid copolymers; polyethylene; a polylactide resin; and blends of any two or more of the foregoing. Thermoset polymers include, for example, isocyanate-based polymers such as polyurethanes, polyureas, polyurethane-ureas, polyisocyanurates, polyurethane-isocyanurates, polyurea-isocyanurates, polyurethane-urea-isocyanurates, and the like, which are produced by the polymerization of a polyisocyanate.

A preferred thermoset polymer is a reaction product of liquid foam precursors that include at least one polyisocyanate, water, a physical blowing agent, and optionally one or more polyols and/or isocyanate-reactive amines. Water in these systems functions as a chemical blowing agent and a chain extender by reacting with isocyanate groups to form a carbamic acid that in turn decomposes to carbon dioxide and an amine. The liberated carbon dioxide functions as a blowing gas, and the amine reacts with another isocyanate group to form a urea linkage, thereby extending the polymer chain. In such cases, the gas-filled cells will contain both carbon dioxide and the physical blowing agent. If one or more polyols are present, these react with isocyanate groups to produce urethane linkages. If isocyanate-reactive amines are present, these react with isocyanate groups to produce urea linkages. Examples of suitable systems for producing rigid, closed-cell isocyanate-based foams are described for example in U.S. Pat. Nos. 5,444,101, 6,753,357 and 8,937,107, US Published Patent Application No. 2015/0025164 and WO 2013/135746.

The foam density may be, for example, 16 to 80 kg/m³ or 24 to 60 kg/m³.

The thickness of the insulation foam layer may be, for example, at least 0.25 cm, at least 1 cm or at least 2 cm, and may be as much as 50 cm, as much as 25 cm, as much as 12 cm or as much as 7.6 cm.

Non-cellular polylactide sheet 3 contains at least 50%, preferably at least 80%, and more preferably at least 90% by weight of one or more polylactide resins. For the purposes of this invention, the terms “polylactide”, “polylactic acid”, and “PLA” are used interchangeably to denote polymers having at least 50% by weight of polymerized lactic units (i.e., those having the structure —OC(O)CH(CH₃)—), irrespective of how those lactic units are formed into the polymer. The polylactide resin may contain at least 80%, at least 90%, at least 95%, or at least 98% by weight of lactic units.

The polylactide may further contain repeating units derived from other monomers that are copolymerizable with lactide or lactic acid, such as alkylene oxides (including ethylene oxide, propylene oxide, butylene oxide, tetramethylene oxide, and the like), cyclic lactones, or carbonates. Repeating units derived from these other monomers can be present in block and/or random arrangements. These other repeating units suitably constitute up to about 10% by weight of the polylactide, preferably from about 0 to about 5% by weight, especially from about 0 to 2% by weight, of the polylactide, and may be absent.

The polylactide may also contain residues of an initiator compound, which is often used during the polymerization process to provide molecular weight control. Suitable such initiators include, for example, water, alcohols, polyhydroxyl compounds of various types (such as ethylene glycol, propylene glycol, polyethylene glycol, polypropylene glycol, other glycol ethers, glycerin, trimethylolpropane, pentaerythritol, hydroxyl-terminated butadiene polymers, and the like), polycarboxyl-containing compounds, and compounds having at least one carboxyl and one hydroxyl group (such as lactic acid or a lactic acid oligomer). The initiator residue preferably constitutes no more than 10%, especially no more than 5%, and especially no more than 2% of the weight of the polylactide, except in the case of a lactic acid or lactic acid oligomer, which can constitute any proportion of the polylactide.

The polylactide may have long-chain branches. Long-chain branches can be introduced in the polylactide in various ways, such as by reacting carboxyl groups on the polylactide with epoxide groups that are present on an acrylate polymer or copolymer. A suitable acrylate polymer or copolymer is characterized in being a solid at 23° C., containing an average of from 2 to about 15 free epoxide groups/molecule (such as about 3 to about 10 or about 4 to about 8 free epoxide groups/molecule), and being a polymerization product of at least one epoxy-functional acrylate or methacrylate monomer, preferably copolymerized with at least one additional monomer. The acrylate polymer or copolymer suitably has a number average molecular weight per epoxide group of about 150 to about 700, such as 200 to 500 or 200 to 400. The acrylate polymer or copolymer suitably has a number average molecular weight of 1000 to 6000, such as about 1500 to 5000 or about 1800 to 3000. Other useful approaches to introducing long-chain branching are described in U.S. Pat. Nos. 5,359,026 and 7,015,302 and in WO 06/002372A2.

The number average molecular weight of the polylactide may be, for example, in the range from 10,000 to 200,000 g/mol, as measured by gel permeation chromatography against a polystyrene standard. Number average molecular weights of about 30,000 to 130,000 g/mol are more preferred.

The polylactide resin is in some embodiments characterized by having a relative viscosity of 2 to 6, preferably 2.5 to 5, more preferably 3.5 to 4.5, as measured using a 1% wt/vol solution of the polylactide resin in chloroform against a chloroform standard on a capillary viscometer at 30° C.

A preferred polylactide is a random copolymer of L-lactic acid and D-lactic acid, a block copolymer of L-lactic acid and D-lactic acid, or a mixture of two or more of these, in each case optionally containing residues of an initiator compound and/or branching agent. The preferred polylactide contains at least 95%, especially at least 98%, by weight repeating lactic units.

The lactic units in the polylactide may be either the L- or D-enantiomer, or mixtures thereof. L- and D-lactic units may be distributed randomly or pseudo-randomly in the polylactide resin molecules.

The ratio of the lactic acid enantiomers and the manner in which they are copolymerized (i.e., randomly, block, multiblock, graft, and like) influence the crystalline behavior of the polylactide.

In some embodiments, the polylactide contains 50 to 92% of one lactic acid enantiomer and 8 to 50% of the other lactic acid enantiomer, or 75 to 92% of one lactic acid enantiomer and 8 to 25% of the other lactic acid enantiomer, in all cases based on the total weight of lactic units.

In other embodiments, the polylactide contains 92 to 100%, preferably 92 to 99.5%, especially 95 to 99.5%, of one lactic acid enantiomer (i.e., either L- or D-lactic units) and up to 8%, preferably from 0.5 to 8%, and especially from 0.5 to 5% of the other lactic acid enantiomer, based on the total weight of lactic units.

Blends of two or more polylactides can be used, for example, to obtain desirable crystallization properties for the blend or to obtain a desired molecular weight distribution.

Therefore, in still other embodiments, the polylactide resin is a mixture of a polylactide resin (a) containing 95 to 100% L-lactic units and having a relative viscosity of 3.5 to 4.5 and 2 to 20%, based on the weight of the mixture, of a polylactide resin (b) containing 95 to 100% L-lactic units and a relative viscosity of 2 to 3.25. Another useful mixture is a mixture of a polylactide resin (a) containing 95 to 100% L-lactic units and having a relative viscosity of 3.5 to 4.5 and 2 to 25%, preferably 5 to 15%, based on the weight of the mixture, of a polylactide resin (c) containing 94 to 100% D-lactic units. Yet another useful mixture includes polylactide resin (a), 2 to 20%, based on the weight of the mixture, of a polylactide resin (b), and 2 to 25%, preferably 5 to 15%, based on the weight of the mixture, of a polylactide resin (c).

The polylactide resin(s) may include virgin materials and/or recycled post-industrial or post-consumer polylactide resin(s).

The polylactide resin (or mixture of resins) may be impact-modified, by which it is meant that the resin or mixture is combined with one or more additives that increase the impact strength of the resin relative to that of the polylactide resin by itself. The Dart impact strength of such an impact-modified polylactide resin is preferably at least 4, more preferably at least 8 Joules, as measured by ASTM D1709. The additive generally includes one or more polymeric materials having a glass transition temperature (T_{g}) of no higher than 20° C. as measured by differential scanning calorimetry (DSC). The T_{g} of the additive may be 0° C. or lower, −20° C. or lower, or −35° C. or lower.

Examples of impact modifiers include, for example, core-shell rubbers. Core-shell rubber rubbers are particulate materials having at least one rubber core encapsulated by at least one shell material. The rubber core has a T_{g} of no more than 0° C., preferably no more than −10° C. The shell material has a T_{g} of at least 50° C., by DSC. The shell material is preferably grafted onto the core, or is crosslinked. The rubber core suitably constitutes from 50 to 90%, especially from 50 to 85% of the weight of the core-shell rubber particle.

Methods for making core-shell rubbers are well known and are described, for example, in U.S. Pat. Nos. 3,655,825, 3,678,133, 3,668,274, 3,796,771, 3,793,402, 3,808,180, 3,843,735, 3,985,703, and 6,989,190. A suitable method is a two-stage polymerization technique in which the core and shell are produced in two sequential emulsion polymerization stages.

Commercially available core-shell rubbers that are suitable include those sold by the Dow Chemical Company under the Paraloid™ brand name, including Paraloid™ KM 355 and Paraloid™ BPM 500 core-shell rubbers, those sold by Kaneka under the KaneAce™ brand name, such as KaneAce ECO-100 core-shell rubber and Metablen™ products such as Metablen S2001, S2006, S2501, and W600A, sold by Mitsubishi Rayon Co., Ltd.

Other impact modifiers include rubbery polyolefins, various acrylic rubbers, ethylene-acrylic acid copolymers (as well as alkali metal salts thereof), ethylene-glycidyl methacrylate copolymers, various silicone rubbers, polymers and copolymers of conjugated dienes, polyurethane rubbers, and the like.

A suitable amount of impact modifier is at least 0.25 parts by weight per 100 parts by weight of polylactide resin(s) and, for example, up to 25 parts, up to 20 parts, up to 15 parts or up to 10 parts per 100 parts by weight of polylactide resin(s).

The polylactide resin(s) may also include one or more crystallization promoters. These include, for example, one or more additives that function as crystal nucleators and/or as crystallization accelerators. Among the suitable crystallization promoters are finely divided solid materials that are thermally stable (i.e., do not melt or degrade) under the conditions of processing the polylactide resin to make the foam insulation structure. Examples of such finely divided solid materials include mineral powders such as talc, various clays and the like, as well as particulate high-melting thermoplastic polymers or thermoset polymers. Other crystallization promoters include acid amide compounds such as are described in EP 1887044, including ethylene bis (lauric acid amide), ethylene bis (isooleic acid amide), and ethylene bis (stearic acid amide). Crystallization accelerators include various plasticizers for the polylactide resin(s), including, for example, various citrate esters, glycerol fatty acid esters, various adipate esters, and the like.

Crystallization promoters are conveniently used in amounts of 0.01 to 10 parts by weight per 100 parts by weight of polylactide resin(s).

Polylactide sheet 3 may contain up to about 45%, preferably up to 30%, by weight of one or more other thermoplastic polymers. Such other thermoplastic polymer(s) preferably are miscible with the polylactide resin(s) contained in polylactide sheet 3.

Polylactide sheet 3 may also contain other ingredients such as colorants, preservatives, anti-oxidants, and/or other stabilizers and biocides. These may constitute up to 10 parts by weight per 100 parts by weight of the polylactide resin(s).

Polylactide sheet 3 may contain polylactide crystallites. Polylactide crystallites are crystals having crystalline melting temperatures of about 140° C. to 240° C., formed by the ordering of polylactide chains in the polylactide sheet. The range of crystalline melting temperatures reflects the number of different crystalline structures that form in polylactide resins, and the fact that the crystallites often have varying amounts of crystal defects that affect their melting temperatures. Polylactide crystallites having melting temperatures of 140° C. to about 195° C. are generally “PLA homocrystals”, which are formed when a single polylactide resin of high enantio-purity crystallizes by itself. Polylactide crystallites having melting temperatures from about 200° C. to 240° C. are typically “stereocomplex” crystallites that form when a polylactide resin containing mostly L-lactic acid enantiomers crystallizes with another polylactide resin containing mostly D-lactic acid enantiomers or from block copolymers with sufficiently enantio-pure blocks of lactic units to allow crystals to form. Polylactide sheet 3 may contain polylactide crystals of either type or both types. Also included within the polylactide crystals are polylactide/blowing agent cocrystals as described below.

Crystallinity in the polylactide sheet is conveniently measured using differential scanning calorimetry (DSC) methods. The amount of such crystallinity is expressed herein in terms of J/g, i.e., the enthalpy of melting, in Joules, of the polylactide crystals in the sample divided by the weight in grams of polylactide(s) in the sample. A convenient test protocol for making DSC measurements is to heat a 5-10 milligram sample from 25° to 225° C. at 20° C./minute under air on a Mettler Toledo DSC 821e calorimeter running Star V. 6.0 software or equivalent apparatus.

In some embodiments, polylactide sheet 3 contains 10 J or less of polylactide crystallites per gram of polylactide resin(s) present in the sheet (J/g). In other embodiments, polylactide sheet contains at least 10 J/g, at least 25 J/g, or at least 35 J/g of polylactide crystallites.

The amount of crystallization present in polylactide sheet 3 will depend on factors that include the particular polylactide resin(s) present, the presence of nucleating agents and/or plasticizers, and the thermal and processing history of the sheet. Heating the sheet, during or following its manufacture, to a temperature between the glass transition temperature of the polylactide resin(s) and its crystalline melting temperature promotes the formation of crystallites. Orienting the polymer during processing also promotes crystal formation.

The embodiment shown in the FIGURE includes optional opposing layer 4 which is affixed to the opposing major surface of polymer foam layer 2. It is generally preferred that opposing layer 4, when present, presents a barrier to the diffusion of atmospheric gases into and the escape of blowing agents from polymer foam layer 2. Opposing layer 4 preferably is non-cellular (as defined above) and sealingly affixed to polymer foam layer 2, for example by virtue of being adhered thereto, either directly or, less preferably, through an optional intermediate adhesive layer (not shown in the FIGURE). Opposing layer 4 preferably is in direct contact with a major surface of polymer foam layer 2, or in direct contact with an adhesive layer that itself is in direct contact with polymer foam layer 2.

In some embodiments, opposing layer 4 is a non-cellular polylactide sheet as described with regard to polylactide sheet 3. Alternatively, opposing layer 4 may be a metal layer; a layer of a different polymer (i.e., a polymer which is not a polylactide resin), which different polymer may be, for example, a thermoplastic or thermoset resin; a composite material; a cellulosic material such as wood, paper, or cardboard; a ceramic material such as glass; and the like. In some embodiments, opposing layer 4 includes one or more recycled post-industrial and/or post-consumer polymers. Opposing layer 4 may be a multilayer structure.

The peripheral edges, such as edges 6 of polymer foam layer 2 also preferably are covered with edge coverings (not shown) that present a barrier to the escape of blowing agents. In especially preferred embodiments, polylactide sheet 3, opposing layer 4, and the edge coverings together form a sealed container that encloses all surfaces of polymer foam layer 2. The edge coverings, when present, may be integrated with opposing layer 4 and/or polylactide sheet 3, if desired.

Polylactide sheet 3 may be a multilayer structure containing at least one non-cellular polylactide resin layer as described above and one or more additional layer(s). The additional layer(s) may be layer(s) of a polylactide resin or layer(s) of another material, such as are described with respect to opposing layer 4. In such a multilayer structure, the layer facing polymer foam layer 2 is a non-cellular polylactide sheet as described before. Because of the unexpectedly good barrier properties of the polylactide sheet 3, it is not necessary that any such additional layers have good barrier properties. Such additional layers may be cellular or non-cellular. In some embodiments, one or more of such additional layers contains one or more recycled post-industrial and/or post-consumer polymers.

Polylactide sheet 3 preferably exhibits a storage modulus, as measured by dynamic mechanical analysis (DMA) at a frequency of 1 Hz and a ramp rate of 5° C./min, of at least 10 MPa at 80° C. In specific embodiments, polylactide sheet 3 exhibits a storage modulus of at least 10 MPa at 100° C., a storage modulus of at least 10 MPa at 120° C., a storage modulus of at least 50 MPa at 80° C., a storage modulus of at least 50 MPa at 100° C., a storage modulus of at least 50 MPa at 120° C., a storage modulus of at least 100 MPa at 80° C., a storage modulus of at least 100 MPa at 100° C. or a storage modulus of at least 100 MPa at 120° C.

Polylactide sheet 3 preferably exhibits a first heat deformation temperature of at least 60° C., preferably at least 80° C., and more preferably at least 90° C. First heat deformation temperature is measured by heating the sheet in an oven at 1° C./min from 25° C. to 125° C., taking images of the samples with a camera every 2 minutes. The images are examined visually to determine the temperature at which deformation or movement of the part is first observed (the first deformation temperature (FDT)).

Polylactide sheet 3 may have a thickness of, for example, 0.05 to 10 mm or more, preferably 0.4 to 10 mm or 0.8 to 5 mm. If polylactide sheet 3 is a layer of a multilayer structure, it preferably has a thickness of 0.05 to 9 mm, more preferably 0.15 to 5 mm and still more preferably 0.8 to 2 mm, and the multilayer structure preferably has a total thickness of 0.4 to 10 mm, more preferably 0.8 to 5 mm.

Although polylactide sheet 3 and opposing layer 4 are represented in the FIGURE as having a planar geometry, this is not necessary. Either or both of polylactide sheet 3 and opposing layer 4 may have non-planar geometries and may be formed into complex shapes to incorporate various functional or other desirable features. Similarly, polymer foam layer 2 may have a non-planar geometry, and may not have a constant thickness.

Foam insulation structure 1 can be made in various ways. In one method, the various layers are made separately and assembled together to form the structure by, for example, the use of adhesive layers, by heat-softening one or more of the layers and then laminating them together so they adhere to each other, or similar methods.

In another method, foam insulation structure 1 can be made in a coextrusion process in which the various layers are simultaneously extruded and the extrudates representing the various layers are brought together while still heat-softened so they adhere together to form the structure.

In other methods, foam insulation structure 1 is made in a foam-in-place method that comprises (1) applying a foam precursor mixture containing at least one polyisocyanate, water, and a physical blowing agent to the surface of polylactide sheet 3 or both polylactide sheet 3 and opposing layer 4, and (2) curing the foam precursor mixture while in contact with polylactide sheet 3 or both polylactide sheet 3 and opposing layer 4 to form polymeric thermal insulation foam layer 2 adhered to polylactide sheet 3 or both polylactide sheet 3 and opposing layer 4. This is a preferred method for making appliance parts such as refrigerator and freezer cabinets and doors as well as smaller thermal insulating products such as coolers.

For example, appliances such as refrigerators and freezers can be manufactured in accordance with the invention by separately producing an inner liner that includes polylactide sheet 3 and an outer shell which corresponds to opposing layer 4. The inner liner and outer shell are positioned together such that a cavity is formed between them. The insulation foam layer 2 is then produced by introducing the foam precursor mixture into the cavity and allowing the precursor to react. As the precursor mixture reacts, it expands to fill the cavity due to the production of gas by the blowing agent(s) and then cures to form polymeric foam layer 2.

The curing of the foam precursor mixture is usually exothermic and therefore experiences a significant temperature rise due to the exothermic heat of reaction. This exposes polylactide sheet 3 to elevated temperatures that may reach, for example, 60° to 160° C. or more. A semi-crystalline polylactide resin (i.e., one containing 25 J/g or more of polylactide crystallites per gram of polylactide) withstands these temperatures better than an amorphous resin (i.e., one containing less that 25 J/g, preferably less than 10 J/g of polylactide crystallites per gram of polylactide). Therefore, when a foam-in-place process is employed to make the thermal insulation structure of the invention, polylactide sheet 3 preferably contains at least 25 J/g of polylactide crystallites.

Planar polylactide sheets 3 are conveniently made using an extrusion process, whereby the polylactide resin(s) and other components of the sheet (including, for example, impact modifiers and crystallization promoters) are combined and heated to a temperature above the crystalline melting temperature of the polylactide resin(s), passing the molten mixture through a die to produce the sheet, and the sheet is subsequently cooled to solidify the polylactide resin(s). If desired, the extruded sheet may be calendered, passed between nip rollers, or otherwise processed to adjust its thickness further.

Polylactide sheets 3 having a non-planar geometry can be produced from planar polylactide sheets via a thermoforming process. In the thermoforming process, the polylactide sheet is softened by heating it to a temperature above the glass transition temperature of the polylactide resin(s), positioning the softened sheet over a positive or negative mold, and drawing and/or pressure forming the sheet on the mold to form a thermoformed part. In such a process, the polylactide sheet may be heated, for example, until it attains a surface temperature of 100° to 200° C., 120° to 200° C., or 120° to 180° C., and then formed on the mold. Surface temperature is conveniently measured by detecting infrared radiation emitted from the surface of the polylactide sheet using an infrared thermometer or an infrared thermal imaging camera.

PLA crystallites can be formed in polylactide sheet 3 by maintaining the sheet within a temperature range between the glass transition temperature and the crystalline melting temperature of the PLA crystallites. To produce a polylactide sheet 3 having a crystallinity of at least 25 J/g, suitable conditions include, for example, maintaining the sheet at a temperature of 80° to 160° C., preferably 80° to 140° C., and more preferably 90° to 130° C. for a period of 30 seconds to five minutes, preferably 45 seconds to 5 minutes, and more preferably 60 seconds to 3 minutes.

Conversely, an amorphous polylactide sheet 3 is produced by avoiding prolonged exposure to crystallization conditions. Some small amount of crystallinity will be produced during the extrusion and/or thermoforming steps described above, as the sheet will necessarily pass through the range of temperatures at which crystallization takes place, as it cools from the process temperatures. In such cases, however, crystallization can be minimized by cooling the resin rapidly to quench it before significant crystallization takes place.

Polylactide sheet 3 can be crystallized during the thermoforming step. This is often desirable to avoid post-demold processing steps to crystallize the thermoformed part. Some crystallization may occur during the step of heating the polylactide sheet in preparation for thermoforming. Some stress-induced crystallization may take place as the sheet is stretched during the forming process. Further crystallization can take place on the mold, particularly if the temperature of the polylactide sheet is maintained within the range of 60° to 160° C., preferably 80° to 140° C., and more preferably 90° to 130° C., and the residence time of the sheet on the mold at such temperature is 30 seconds to 10 minutes, preferably 45 seconds to 5 minutes, and more preferably 60 seconds to 2 minutes.

The thermoforming process can be conducted using apparatus and general methods such as are described, for example, by Throne in “Thermoforming Crystallizing Poly(ethylene terephthalate) (CPET)”, Advances in Polymer Technology, Vol. 8, 131-146 (1988). Drawing is preferably performed using vacuum. The mold may include a positive half that is inserted into the negative half during the process to provide positive mold forming. It may also be desirable to pre-stretch the sheet; if so, a pressure cap or other pre-stretching device may be used and actuated prior to drawing the sheet into the mold. Once the part is formed and cooled below its T_{g}, it is demolded and trimmed if necessary.

The foam insulation structure of the invention is useful as cabinets and doors for appliances such as refrigerators and freezers; for making coolers and other insulated containers; for making insulated walls, roofs, ceilings of buildings, and other constructions; for insulating and as insulation structures for insulating ship hulls, refrigerated vehicles, and the like.

The foam insulation structure of the invention experiences a surprisingly slow loss of thermal insulation efficiency over time due to the slow diffusion of atmospheric gases and of blowing agents through the polylactide sheet. Typically, the structure exhibits an initial rise of thermal conductivity or k-factor as it is aged. This initial rise in k-factor may be exhibited, for example, over a period of a few days to about 2 weeks, and is believed to be attributable to the diffusion of air and moisture that is trapped during construction of the structure and diffusion into the foam where it equilibrates, resulting in an increased k-factor. Such an initial rise in k-factor is typical of foam insulation structures in which a polymer foam is encased with an outer shell structure.

With conventional foam insulation structures having a HIPS or similar shell, a significant but more gradual increase in k-factor is seen over time, once the initial, rapid increase in k-factor is completed. In those conventional foam structures, this more gradual increase is due to the diffusion of air and moisture into the closed cells of the foam, and the slow diffusion of blowing agents out of the closed cell. Such a mechanism is described, for example, by Wilkes et al., “Aging of Polyurethane Foam Refrigerator Panels—Initial Results with Third Generation Blowing Agents”, presented at The Earth Technologies Forum, Washington, D.C., Oct. 26-28, 1998.

Unlike those conventional foam insulation structures just described, the k-factor of the foam insulation structure of this invention changes very slowly with time after that initial increase due to the equilibration of trapped air. The rate of k-factor increase is often close to zero for extended periods of time.

Although the invention is not limited to any theory, the excellent barrier properties of the polylactide resin sheet may be attributable at least in part to the formation of cocrystals of the polylactide resin and the physical blowing agent. As the physical blowing agent escapes from polymer foam layer 2 and migrates into polylactide sheet 3, the blowing agent is believed to form cocrystals with the polylactide resin. Thus the polylactide resin forms a crystalline complex (Σ-form cocrystals) with the physical blowing agent with the consequent encapsulation of the cocrystals by the host polylactide resin, (see P. Shaiju et al., Macromolecules 2016, 49, 224-233 and Hironori Marubayashi, et al., J. Phys. Chem. B 2013, 117, 385-397). The presence of these cocrystals is believed to contribute to the barrier properties of the polylactide sheet. Loss of the physical blowing agent through the polylactide sheet is slowed because it is captured in or by the cocrystals. Capture of the physical blowing agent in the polylactide sheet and subsequent cocrystallization creates a barrier that prevents or at least slows the migration of the physical blowing agent into the sheet from the polymer foam layer.

Accordingly, in another aspect, this invention is a polylactide article containing cocrystals of a polylactide resin and a compound selected from one or more of a hydrocarbon having 3 to 8 carbon atoms; a cycloalkane having 4 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms. The presence of the polylactide resin/blowing agent cocrystals can be determined using X-ray scattering methods, such as are described, for example, by Shaiju et al., Macromolecules 2016, 49, 224-233.

The invention is also a method of producing cocrystals of a polylactide resin and a compound in a polylactide article containing a polylactide resin, comprising contacting a compound selected from one or more of hydrocarbon having 3 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms with the surface of the polylactide article, and diffusing the compound into the polylactide article to produce the cocrystals.

The diffusion step can be performed at a temperature from −40° C. to 160° C., but preferably is performed at a temperature of −30° C. to 160° C. and may be performed at a temperature of −20° C. to 40° C. The diffusion step can be performed at a sub-atmospheric, atmospheric, or super-atmospheric pressure. The diffusion step can be performed for a period ranging from one minute to 10 years or more. The polylactide resin may be a neat polylactide resin, an impact-modified polylactide resin as described hereinbefore, or other blend of a polylactide resin with one or more other components. If a blend, the blend may contain at least 50%, at least 75%, or at least 90% by weight of polylactide resin(s).

In some embodiments, the step of applying the compound to the surface of the polylactide resin article is performed by contacting the surface of the polylactide resin article with a polymeric foam having closed cells that contain the compound. In such a case, the compound may have been a blowing agent used to produce the polymer foam. The polymeric foam may be any of the types described above.

The following examples illustrate the invention, but are not intended to limit it in any way. All parts and percentages are by weight unless otherwise indicated.

Polylactide A is a linear, random copolymer containing 95.5% L-lactic units and 4.5% D-lactic units having a relative viscosity of 3.5 to 4.5.

Polylactide B is a linear, random copolymer containing about 99.5% L-lactic enantiomer units and 0.5% D-lactic enantiomer units having a relative viscosity of 2 to 3.25.

Polylactide C is a linear, random copolymer containing 1% L-lactic enantiomer units and 99% D-lactic enantiomer units.

Polylactide D is a linear, random copolymer containing 99.75% L-lactic units and 0.25% D-lactic units having a relative viscosity of 3.5 to 4.5.

### EXAMPLE 1

A mixture of 95% of Polylactide A, 2.5% titanium dioxide particles, and 2.5% by weight of a core-shell rubber is extruded into duplicate 1.2-mm-thick, non-cellular sheets on a single screw extruder. The extruded sheets each contain less than 10 Joules of polylactide crystallinity per gram of polylactide resin.

A 50-mm-thick layer of a closed-cell, rigid polyurethane foam is formed between the extruded polylactide sheets in a pour-in-place process, to form a three-layer sandwich structure with the foam layer in the center. The polyurethane foam is a product obtained by reacting a polyisocyanate, a polyol mixture, and water in the presence of cyclopentane, and therefore contains a mixture of carbon dioxide and cyclopentane in its cells. All exposed edges of the foam layer are covered with a gas-impermeable metallic tape.

The thermal conductivity of the resulting assembly (Ex. 1) is measured according to DIN 52616 at a mean temperature of 10° C. The assembly is then aged for 629 days under atmospheric pressure air at a temperature of 23±2° C. and 50±5% relative humidity. The thermal conductivity is measured periodically during and at the end of the aging period.

For comparison, a similar assembly (Comp. Sample A) is prepared and evaluated in the same way, replacing the polylactide sheets with layers of non-cellular high impact polystyrene (HIPS) of equivalent thickness.

The results of the testing are as follows:

Thermal Conductivity, mW/K/m

| Aging Time | Example 1 | Comp. Sample A |
|---|---|---|
| Initial | 20.7 | 20.5 |

| | | | |
|---|---|---|---|
| 7 | days | 21.5 | 21.1 |
| 13 | days | 21.6 | 21.3 |
| 20 | days | 21.7 | 21.3 |
| 27 | days | 21.7 | 21.4 |
| 56 | days | 21.8 | 21.5 |
| 118 | days | 21.5 | 22.0 |
| 146 | days | 21.6 | 22.5 |
| 181 | days | 21.4 | 22.7 |
| 244 | days | 21.3 | 23.6 |
| 260 | days | 21.5 | 24.0 |
| 455 | days | 21.1 | 24.9 |
| 629 | days | 21.4 | 25.8 |

The assemblies each have similar thermal conductivities initially, and in each case there is an increase of about 5% over the initial value over the first 27 days of aging. As discussed above, this is believed to be attributable to atmospheric gases that are trapped during construction of the foam structure and equilibrate into the foam. With additional aging, the thermal conductivities of Example 1 and Comparative Sample A diverge dramatically. Comparative Sample A continues to exhibit a regular and large increase in thermal conductivity during the entire course of the evaluation, which is attributable to the gradual diffusion of atmospheric gases and blowing agents through the HIPS layer. Example 1, on the other hand, exhibits no such increase. The behavior of Example 1 suggests that, after an initial period, the diffusion of gases into and out of the polymer foam layer decreases to very low levels, if it is not stopped altogether.

### EXAMPLE 2

A dry-blended mixture of about 80% of Polylactide A, about 10% of Polylactide B and about 10% of Polylactide C is extruded into 1.3-mm sheets on a single screw extruder. The extruded sheet is formed on chill rolls set at temperatures of 35-40° C. to quench the sheet and maintain the crystallinity at less than 10 J/g.

The first deformation temperature of one of the sheets is about 56° C.

Duplicate sheet samples are thermoformed on an off-line, roll-fed Kiefel thermoformer. A cup mold [2.75-in (base)×3.5-in (top)×2.25-in (height)] with a draw ratio≈4× is used to thermoform the parts. The sheets are heated to surface temperatures as indicated in Table 1, and then thermoformed in the cup mold. The mold temperature is 90° C. Residence time on the mold is 30 seconds.

The crystallinity of the walls and the base of the thermoformed parts is measured by DSC. Thermoformed parts are subjected to first deformation test (FDT) as described before. Results are as indicated in Table 1.

TABLE 1

| Sheet surface | Side wall | Base | |
|---|---|---|---|
| temperature | crystallinity | crystallinity | FDT |
| (° C.) | (J/g) | (J/g) | (° C.) |
| 127° | 47.9 | 30.9 | 90° (4 min) |
| 148° | 44.9 | 44.6 | 90° (4 min) |
| 158° | 43.8 | 22.1 | 90° (4 min) |
| 168° | 42.1 | 24.3 | 90° (4 min) |

The FDT of the thermoformed parts indicates that semi-crystalline polylactide sheet is thermally stable enough to be used to produce foam insulation structures of the invention in a pour-in-place process. A wide processing window of 127° C. to at least 168° C. can be used in thermoforming this polylactide resin blend.

### EXAMPLE 3

Polylactide sheet samples are extruded in the general manner described in Example 2. The ingredients are i) about 80% of Polylactide D; ii) 8-10% of Polylactide B, iii) 8-10% of a Polylactide C, iv) 2-3% of titanium dioxide powder and v) 0.2 to 0.5% of ethylene bis (stearic acid amide). This mixture is formulated to crystallize more rapidly than the resin blend in Example 2.

Duplicate samples of the sheet are thermoformed in the same manner described in Example 2, except somewhat higher sheet temperatures are achieved, as indicated in Table 2. Crystallinity and FDT are determined as in Example 2. Results are as indicated in Table 2.

TABLE 2

| Sheet surface | Side wall | Cup base | |
|---|---|---|---|
| temperature | crystallinity | crystallinity | FDT |
| (° C.) | (J/g) | (J/g) | (° C.) |
| 175° | 49.8 | 48.0 | >90° |
| 180° | 49.4 | 47.6 | >90° |
| 184° | 44.6 | 48.9 | >90° |

Again, the FDT of the thermoformed parts indicates that the thermoformed sheet is thermally stable enough to be used to produce foam insulation structures of the invention in a pour-in-place process and to remain undistorted when submitted to a thermal cycling test that includes a step of heating the sheet to 50° C. to 60° C. for 12 to 24 hours. A somewhat higher processing temperature can be used in a fast-crystallizing system such as used in Example 3.

### Specific Embodiments

1. A foam insulation structure comprising (a) a polymer foam layer having opposing major surfaces and gas-filled cells that contain a physical blowing agent and (b) a non-cellular polylactide sheet containing at least 50% by weight of one or more polylactide resins, wherein said non-cellular polylactide sheet (b) is sealingly affixed to at least one of said opposing major surfaces of the polymer foam layer.

2. The foam insulation structure of embodiment 1 wherein the physical blowing agent is selected from one or more of a hydrocarbon having 3 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms.

3. The foam insulation structure of embodiment 1 wherein the physical blowing agent includes a hydrocarbon having 3 to 8 carbon atoms.

4. The foam insulation structure of embodiment 3 wherein the physical blowing agent includes cyclopentane.

5. The foam insulation structure of any preceding embodiment wherein the polymer foam is a reaction product of a foam precursor mixture containing at least one polyisocyanate, water, and the physical blowing agent.

6. The foam insulation structure of any preceding embodiment wherein the non-cellular polylactide sheet contains no more than 10 Joules of polylactide crystallites per gram of polylactide resin(s) in the polylactide resin sheet.

7. The foam insulation structure of any preceding embodiment wherein the non-cellular polylactide sheet contains at least 25 Joules of polylactide crystallites per gram of polylactide resin(s) in the polylactide resin sheet.

8. The foam insulation structure of any preceding embodiment wherein the non-cellular polylactide sheet contains polylactide crystallites, and the polylactide crystallites include cocrystals of the polylactide resin(s) and the physical blowing agent.

9. The foam insulation structure of any preceding embodiment wherein the polylactide resin is impact-modified.

10. The foam insulation structure of any preceding embodiment wherein the polylactide resin includes a core-shell rubber.

11. The foam insulation structure of any preceding embodiment wherein the polylactide resin includes at least one crystallization promoter.

12. The foam insulation structure of any preceding embodiment wherein the non-cellular polylactide sheet has a thickness of 0.5 to 10 mm.

13. The foam insulation structure of any preceding embodiment, wherein the non-cellular polylactide sheet has a storage modulus of at least 50 MPa at 100° C.

14. The foam insulation structure of any preceding embodiment, wherein the non-cellular polylactide sheet has a first distortion temperature of at least 80° C.

15. The foam insulation structure of any preceding embodiment, wherein the non-cellular polylactide sheet is a layer of a multilayer structure, the non-cellular polylactide sheet has a thickness of 0.15 to 9 mm, and the multilayer structure has a total thickness of 0.8 to 10 mm

16. The foam insulation structure of embodiment 15, wherein the multilayer structure has a storage modulus of at least 50 MPa at 100° C.

17. The foam insulation structure of embodiment 15 or 16, wherein the multilayer structure has a first deformation temperature of at least 80° C.

18. The foam insulation structure of any preceding embodiment, wherein the non-cellular polylactide sheet has a non-planar geometry produced by thermoforming.

19. The foam insulation structure of any preceding embodiment, wherein a non-cellular polylactide sheet is sealingly affixed to each opposing major surface of the polymer foam layer.

20. The foam insulation structure of any of embodiments 1-18, wherein a metal layer is sealingly affixed to a major surface of the polymer foam layer.

21. The foam insulation structure of any preceding embodiment, wherein the polymer foam layer has a thickness of 0.25 cm to 12 cm.

22. The foam insulation structure of any preceding embodiment, which constitutes all or a portion of an appliance cabinet or door.

23. A method for producing a foam insulation structure comprising (1) applying a foam precursor mixture containing at least one polyisocyanate, water, and a physical blowing agent to the surface of a non-cellular polylactide sheet that contains at least 50% by weight of a polylactide resin, which sheet contains at least 25 Joules of polylactide crystallites per gram of polylactide resin in the non-cellular polylactide sheet, and (2) curing the foam precursor mixture while in contact with the non-cellular polylactide sheet to form a polymer foam layer adhered to the polylactide sheet.

24. The method of embodiment 23 wherein the physical blowing agent is selected from one or more of a hydrocarbon having 3 to 8 carbon atoms; a fluorocarbon, hydrofluorocarbon, fluorochlorocarbon, or hydrofluorochlorocarbon having up to 6 carbon atoms; a hydrohaloolefin having up to 6 carbon atoms; and a dialkyl ether having up to 6 carbon atoms.

25. The method of embodiment 23 wherein the physical blowing agent includes a hydrocarbon having 3 to 8 carbon atoms.

26. The method of embodiment 25 wherein the physical blowing agent includes cyclopentane.

27. The method of any of embodiments 23-26 wherein the polylactide resin is impact-modified.

28. The method of embodiment 27 wherein the polylactide resin includes a core-shell rubber.

29. The method of any of embodiments 23-28 wherein the polylactide resin includes at least one crystallization promoter.

30. The method of any of embodiments 23-29 wherein the non-cellular polylactide sheet has a thickness of 0.8 to 10 mm.

31. The method of any of embodiments 23-30, wherein the non-cellular polylactide sheet has a storage modulus of at least 50 MPa at 100° C.

32. The method of any of embodiments 23-31, wherein the non-cellular polylactide sheet has a first deformation temperature of at least 80° C.

33. The method of any of embodiments 23-29, wherein the non-cellular polylactide sheet is a layer of a multilayer structure, the non-cellular polylactide sheet has a thickness of 0.15 to 1.5 mm, and the multilayer structure has a total thickness of 0.5 to 10 mm.

34. The method of embodiment 33, wherein the multilayer structure has a storage modulus of at least 50 MPa at 100° C.

35. The method of embodiments 33 or 34, wherein the multilayer structure has a first deformation temperature of at least 80° C.

36. The method of any of embodiments 23-35, wherein the non-cellular polylactide sheet has a non-planar geometry produced by thermoforming.

37. The method of any of embodiments 23-36, wherein the foam precursor mixture is dispensed into a cavity formed by the non-cellular polylactide sheet or a multilayer structure that includes the non-cellular polylactide sheet and a layer of a metal and cured within the cavity to form a polymer foam layer adhered to the non-cellular polylactide sheet and the metal layer.

38. The method of any of embodiments 23-37, wherein the foam insulation structure forms all or part of an appliance cabinet or door.

39. A polylactide article containing cocrystals of a polylactide resin and a compound selected from one or more of a hydrocarbon having 3 to 8 carbon atoms; a cycloalkane having 4 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms.

40. The polylactide article of embodiment 39, wherein the compound includes a hydrocarbon having 3 to 8 carbon atoms.

41. The polylactide article of embodiment 39, wherein the compound includes cyclopentane.

42. The polylactide article of any of embodiments 39-41 which contains at least 25 J/g of PLA crystallites, including the cocrystals.

43. A method of producing cocrystals of a polylactide resin and a compound in a polylactide article containing a polylactide resin, comprising contacting a compound selected from one or more of hydrocarbon having 3 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms with the surface of the polylactide article, and diffusing the compound into the polylactide article to produce the cocrystals.

44. The method of embodiment 43, wherein the compound includes cyclopentane.

45. The method of embodiment 43 or 44, wherein the polylactide is impact-modified.

46. The method of any of embodiments 43-45, wherein the step of applying the compound to the surface of the polylactide article is performed by contacting the surface of the polylactide article with a polymeric foam having closed cells that contain the compound.

1. A foam insulation structure comprising (a) a polymer foam layer having opposing major surfaces and gas-filled cells that contain a physical blowing agent which polymer foam is a reaction product of a foam precursor mixture containing at least one polyisocyanate, water, and the physical blowing agent, and (b) a non-cellular polylactide sheet containing at least 50% by weight of one or more polylactide resins, wherein said non-cellular polylactide sheet (b) contains at least 25 Joules of polylactide crystallites per gram of polylactide resin(s) in the polylactide resin sheet and is sealingly affixed to at least one of said opposing major surfaces of the polymer foam layer.

2. The foam insulation structure of claim 1 wherein the physical blowing agent is selected from one or more of a hydrocarbon having 3 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms.

3. (canceled)

4. The foam insulation structure of claim 2 wherein the physical blowing agent includes cyclopentane.

5-7. (canceled)

8. The foam insulation structure of claim 1 wherein the polylactide crystallites include cocrystals of the polylactide resin(s) and the physical blowing agent.

9-11. (canceled)

12. The foam insulation structure of claim 1 wherein the non-cellular polylactide sheet has a thickness of 0.5 to 10 mm, a storage modulus of at least 50 MPa at 100° C. and a first distortion temperature of at least 80° C.

13-14. (canceled)

15. The foam insulation structure of claim 1, wherein the non-cellular polylactide sheet is a layer of a multilayer structure, the non-cellular polylactide sheet has a thickness of 0.15 to 9 mm, and the multilayer structure has a total thickness of 0.8 to 10 mm.

16. The foam insulation structure of claim 15, wherein the multilayer structure has a storage modulus of at least 50 MPa at 100° C. and a first deformation temperature of at least 80° C.

17. (canceled)

18. The foam insulation structure of claim 1, wherein the non-cellular polylactide sheet has a non-planar geometry produced by thermoforming.

19-20. (canceled)

21. The foam insulation structure of claim 1, wherein the polymer foam layer has a thickness of 0.25 cm to 12 cm.

22. The foam insulation structure of claim 1, which constitutes all or a portion of an appliance cabinet or door.

23. A method for producing a foam insulation structure comprising (1) applying a foam precursor mixture containing at least one polyisocyanate, water, and a physical blowing agent to the surface of a non-cellular polylactide sheet that contains at least 50% by weight of a polylactide resin, which sheet contains at least 25 Joules of polylactide crystallites per gram of polylactide resin in the non-cellular polylactide sheet, and (2) curing the foam precursor mixture while in contact with the non-cellular polylactide sheet to form a polymer foam layer adhered to the polylactide sheet.

24-38. (canceled)

39. A polylactide article containing cocrystals of a polylactide resin and a compound selected from one or more of a hydrocarbon having 3 to 8 carbon atoms; a cycloalkane having 4 to 8 carbon atoms; a fluorocarbon, hydrofluorocarbon, fluorochlorocarbon, or hydrofluorochlorocarbon having up to 8 carbon atoms; a hydrohaloolefin having up to 8 carbon atoms; and a dialkyl ether having up to 8 carbon atoms, which polylactide article contains at least 25 J/g of PLA crystallites, including the cocrystals.

40. The polylactide article of claim 39, wherein the compound includes a hydrocarbon having 3 to 8 carbon atoms.

41. The polylactide article of claim 39, wherein the compound includes cyclopentane.

42-46. (canceled)
